(19) United States
(12) Patent Application Publication
(10) Pub. No.: US 2026/0171555 A1
(43) Pub. Date: Jun. 18, 2026

(54) ELECTRICITY STORAGE DEVICE

(71) Applicant: Prime Planet Energy & Solutions, Inc., Tokyo (JP)

(72) Inventor: Yuta ORIHARA, Toyota-shi (JP)

(21) Appl. No.: 19/412,850

(22) Filed: Dec. 9, 2025

(30) Foreign Application Priority Data
Dec. 16, 2024 (JP) 2024-220180

(51) Int. Cl. H01M 50/103; H01G 11/78; H01M 10/0587

(52) U.S. Cl. CPC H01M 50/103; H01G 11/78; H01M 10/0587

(57) ABSTRACT

The herein disclosed electricity storage device includes the case and an electrode assembly accommodated in the case. The case includes a first wall having a first side and a second side, and includes a second wall being opposed to the first wall. The electrode assembly includes a laminate part in which the positive electrode and the negative electrode are laminated along an opposed direction of the first wall and the second wall. The first wall includes a base part and a hollow part protruding from the base part toward the electrode assembly. The hollow part includes an inclined part from the base part toward the electrode assembly and a bottom part that is positioned closer to the electrode assembly than the base part. The base part includes a recessed part between the hollow part and the first side.

### CROSS REFERENCE TO RELATED APPLICATIONS

The present application is based on, and claims priority from, Japanese Patent Application No. 2024-220180 filed on Dec. 16, 2024, the disclosure of which is hereby incorporated by reference herein in its entirely.

### BACKGROUND OF THE DISCLOSURE

The present disclosure relates to an electricity storage device.

Each of Japanese Patent Application Publication No. H11-031523, Japanese Patent Application Publication No. 2000-067821, and Japanese Patent Application Publication No. 2024-116777 discloses a case whose side surface is dented toward an electrode assembly side at an inside the case.

### SUMMARY

The electrode assembly is expanded by an electrical charge. Accordingly, a force pushing a wall part from an inner side toward an outer side is generated, while the wall part configures the case. When the wall part is pushed, a stress is concentrated on an end part of the wall part (for example, a corner part of the case). If the stress is concentrated, it can cause a breakage of the case. Thus, it is desired to implement a technique for reducing the stress generated on the end part of the wall part.

One aspect of the herein disclosed technique is an electricity storage device that includes a case and an electrode assembly that is accommodated in the case. The case includes a first wall that has an outer edge containing a first side and a second side being opposed to the first side, and includes a second wall that is opposed to the first wall. The electrode assembly includes a laminate part in which a positive electrode and a negative electrode are laminated along an opposed direction of the first wall and the second wall in a state of being insulated. The first wall includes a base part, and a hollow part that is configured to protrude from the base part toward the electrode assembly. The hollow part includes an inclined part that is inclined from the base part toward the electrode assembly, and includes a bottom part that is positioned closer to the electrode assembly than the base part. The base part includes a recessed part that is positioned between the hollow part and the first side and that is recessed toward an inner side or an outer side of the case.

The electricity storage device described above may reduce the stress generated on the end part of the first wall configuring the case.

### BRIEF DESCRIPTION OF THE DRAWINGS

FIG. 1 is a perspective view that schematically shows a configuration of an electricity storage device 1.

FIG. 2 is a schematic view that shows an inside structure of the electricity storage device 1.

FIG. 3 is a cross section view that is schematically shown along an III-III line of FIG. 1.

FIG. 4 is a schematic view in which a case 100 is decomposed.

FIG. 5 is a schematic view in which an electrode assembly 20 is decomposed.

FIG. 6 is a perspective view that schematically shows a configuration of an electricity storage device 1A being a modified example.

FIG. 7 is a cross section view that is schematically shown along a VII-VII line of FIG. 6.

### DETAILED DESCRIPTION

Below, some embodiments of a technique disclosed herein would be described in detail, by reference to accompanying drawings. The matters other than matters particularly mentioned in this description, and required for practicing the present disclosure (for example, a general configuration of the electricity storage device, manufacture process, or the like, which does not characterize the present disclosure) can be grasped as design matters of those skilled in the art based on the related art in the present field. The present disclosure can be implemented on a basis of contents disclosed in the present specification and a common general technical knowledge.

In the present specification, a term “electricity storage device” represents a concept semantically covering a device that can generate a charge and discharge response by having an electrical charge carrier moving between a pair of electrodes (a positive electrode and a negative electrode). In other words, the electricity storage device semantically covers a battery, such as secondary battery (for example, a lithium ion secondary battery, a nickel hydrogen battery, and a nickel cadmium battery), and a capacitor (a physical battery), such as lithium ion capacitor and electric double layer capacitor.

In the present description, a wording “approximately rectangular shape” means not only a completely rectangular shape (an oblong shape), but also a shape which can be regarded as a substantially rectangular shape. The shape which can be regarded as a substantially rectangular shape can be, for example, a rectangular shape in which a corner part connecting a long side and a short side is formed to be an R shape, a shape having a notch, or the like.

### Electricity Storage Device

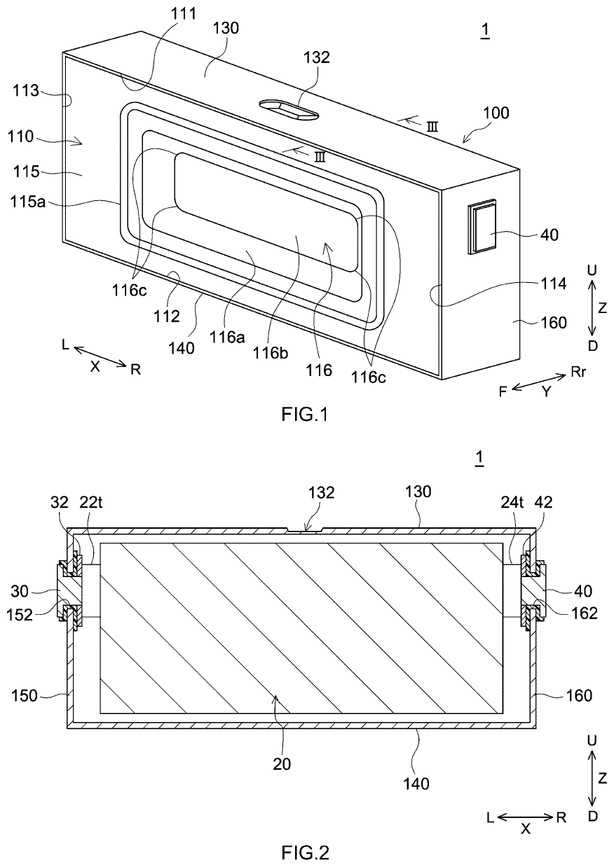

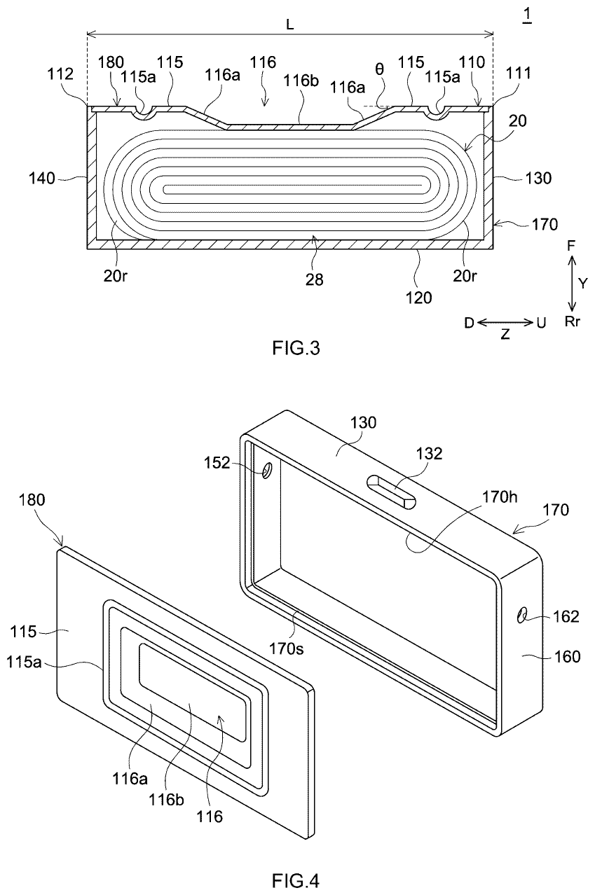

Below, an electricity storage device 1 in accordance with one embodiment will be described. FIG. 1 is a perspective view that schematically shows a configuration of the electricity storage device 1. FIG. 2 is a schematic view that shows an inside structure of the electricity storage device 1. FIG. 3 is a cross section view that is schematically shown along an III-III line of FIG. 1. FIG. 4 is a schematic view in which a case 100 is decomposed. Reference signs L, R, F, Rr, U, and D in drawings respectively show left, right, front, rear, up, and down. Reference signs X, Y, and Z in drawings respectively show a short side direction, a long side direction being orthogonal to the short side direction, and a vertical direction, of the electricity storage device 1. However, these are merely directions for convenience sake of explanation, and are not intended to restrict a disposed form of the electricity storage device 1. Incidentally, each drawing is schematically drawn, and thus a dimensional relation (such as length, width, and thickness) might not always reflect an actual dimensional relation. Additionally, in drawings described below, the same numerals and signs are given to the members/parts providing the same effect, and overlapped explanations might be omitted or simplified.

As shown in FIG. 1 to FIG. 3, the electricity storage device 1 includes a case 100 and an electrode assembly 20. The electrode assembly 20 is accommodated in the case 100. The electricity storage device 1 further includes a positive electrode terminal 30 and a negative electrode terminal 40. The electricity storage device 1 herein is a lithium ion secondary battery. The electricity storage device 1 is a so-called sealed battery. In this embodiment, the electricity storage device 1 further includes a nonaqueous electrolytic solution (not shown in drawings).

(1) Case 100

As shown in FIGS. 1 to 4, the case 100 is formed in a square shape being an approximately rectangular parallelepiped. The case 100 includes a first wall 110, a second wall 120, a first side wall 130, a second side wall 140, a third side wall 150, and a fourth side wall 160.

The first wall 110 and the second wall 120 are configured to form a pair of wide width surfaces of the case 100. The first wall 110 and the second wall 120 have outer surfaces whose area sizes are larger than the other surfaces of the case 100. The first wall 110 and the second wall 120 are opposed to each other in the short side direction Y. The first wall 110 herein is formed in a plate shape. The first wall 110 has an outer edge formed in an approximately rectangular shape, when being viewed from an F side to an Rr side of the short side direction Y in drawings. The first wall 110 has the outer edge including a first side 111 and a second side 112 being opposed to the first side 111. The outer edge of the first wall 110 has a pair of long sides and a pair of short sides. In the present embodiment, the first wall 110 has the first side 111 and the second side 112, as the pair of long sides, and has a third side 113 and a fourth side 114, as the pair of short sides.

The second wall 120 is opposed to the first wall 110. The second wall 120 herein is formed in a plate shape. The second wall 120 has an outer edge formed in an approximately rectangular shape, when being viewed from the Rr side to the F side in the short side direction Y. The outer edge of the second wall 120, has a pair of long sides and a pair of short sides.

The first side wall 130 and the second side wall 140 are opposed to each other, and are configured to form a pair of side walls. The first side wall 130 and the second side wall 140 herein are formed in plate shapes. The first side wall 130 and the second side wall 140 have outer edges formed in approximately rectangular shapes, when viewed from the vertical direction Z in drawings. The first side wall 130 is configured to extend from the first side 111 being the long side of the first wall 110 to the long side of the second wall 120. The second side wall 140 is configured to extend from the second side 112 being the long side of the first wall 110 to the long side of the second wall 120.

The third side wall 150 and the fourth side wall 160 are opposed to each other, and are configured to form a pair of side walls. The third side wall 150 and the fourth side wall 160 herein are formed in plate shapes. The third side wall 150 and the fourth side wall 160 have outer edges formed in approximately rectangular shapes, when being viewed from the long side direction X in drawings. The third side wall 150 is configured to extend from the third side 113 being the short side of the first wall 110 to the short side of the second wall 120. The fourth side wall 160 is configured to extend from the fourth side 114 being the short side of the first wall 110 to the short side of the second wall 120.

As shown by FIG. 4, in the present embodiment, the case 100 includes a case main body 170 having an opening 170h and includes a sealing body 180 being installed on the opening 170h. In the case 100, the case main body 170 includes the second wall 120, the first side wall 130, the second side wall 140, the third side wall 150, and the fourth side wall 160. The sealing body 180 is a main member that configures the first wall 110. In the present embodiment, each of the case main body 170 and the sealing body 180 is formed with aluminum, or an aluminum alloy in which the aluminum is main component.

The case main body 170 is formed in a square shape of an approximately rectangular parallelepiped that has an opening 170h on one side surface. The case main body 170 includes the second wall 120 as a bottom wall. From the pair of long sides of the second wall 120, the first side wall 130 and the second side wall 140 are respectively configured to be erected. From the pair of short sides of the second wall 120, the third side wall 150 and the fourth side wall 160 are respectively configured to be elected. The opening 170h is formed to be surrounded by the first side wall 130, the second side wall 140, the third side wall 150, and the fourth side wall 160. In the present embodiment, as shown by FIG. 4, the opening 170h is provided with a dented step 170s along an inner edge.

The case 100 includes a safe valve 132. Here, the safe valve 132 is provided on the first side wall 130. The safe valve 132 is configured to be broken, when a pressure inside the case 100 reaches a value being equal to or more than a predetermined value, and then to exhaust the gas inside the case 100 to an outside. Here, the safe valve 132 is formed to be the thinnest of the first side wall 130. Incidentally, the safe valve 132 might be provided on a wall of the case 100 other than the first side wall 130.

The case 100 has a first penetration hole 152 and a second penetration hole 162 which are configured to communicate the inside and the outside of the case 100. The first penetration hole 152 is provided on the third side wall 150. At the first penetration hole 152, the positive electrode terminal 30 is installed. The second penetration hole 162 is provided on the fourth side wall 160. At the second penetration hole 162, the negative electrode terminal 40 is installed. Incidentally, neither a position of the first penetration hole 152 nor a position of the second penetration hole 162 is particularly restricted. For example, the first penetration hole 152 and the second penetration hole 162 might be provided on the same wall.

The sealing body 180 is configured to seal the opening 170h of the case main body 170. The sealing body 180 is fit into the dent step 170s of the case main body 170. A boundary part between the outer edge of the sealing body 180 and an inner side surface of the case main body 170 is welded by a laser. In the present embodiment, the first wall 110 is configured with an outer side surface of the sealing body 180 and with end surfaces of respective side walls of the case main body 170 coming into contact with the outer edge of the sealing body 180. In the present embodiment, the first side 111 of the first wall 110 is a long side of the first side wall 130 at the opening 170h side. The second side 112 of the first wall 110 is a long side of the second side wall 140 at the opening 170h side. The third side 113 of the first wall 110 is a long side of the third side wall 150 at the opening 170h side. The fourth side 114 of the first wall 110 is the long side of the fourth side wall 160 at the opening 170h side.

The first wall 110 (here, the sealing body 180) includes a base part 115 and a hollow part 116. The base part 115 has a recessed part 115a.

As shown in FIG. 1, the base part 115 is a portion between the outer edge of the first wall 110 and the hollow part 116. The base part 115 is, for example, formed in a plate shape. There is a space between the base part 115 and the electrode assembly 20, and thus it is configured to prevent an inner side surface of the base part 115 and the electrode assembly 20 from coming into contact with each other.

The hollow part 116 is a portion configured to protrude from the base part 115 toward an inner side of the case 100. In other words, the hollow part 116 is a portion configured to protrude from the base part 115 toward the electrode assembly 20. The hollow part 116 includes an inclined part 116a and a bottom part 116b. The bottom part 116b is positioned closer to the electrode assembly 20 than the base part 115.

The bottom part 116b of the hollow part 116 is a portion that is pushed by electrode assembly 20 when the electrode assembly 20 is expanded. The bottom part 116b is opposed to the electrode assembly 20. For more detail, the bottom part 116b is opposed to a later described laminate part 28 of the electrode assembly 20. In the present embodiment, the bottom part 116b is configured to directly come into contact with the electrode assembly 20. The bottom part 116b is formed continuously to the inclined part 116a. The bottom part 116b is surrounded by the inclined part 116a. When being viewed from the F side to the Rr side in the short side direction Y of FIG. 1, the bottom part 116b is formed in an approximately rectangular shape that includes a R-shaped (curve line) corner 116c. Here, the bottom part 116b includes a pair of long sides which are parallel to the first side 111 and the second side 112 of the first wall 110, and includes a pair of short sides which are parallel to the third side 113 and the fourth side 114. The corner 116c formed in the R shape may reduce a stress applied to the corner 116c and to prevent a breakage.

The bottom part 116b of the hollow part 116 is provided to be spaced apart from the outer edge of the first wall 110. In the present embodiment, the pair of long sides (the first side 111 and the second side 112) of the first wall 110 are provided at positions closer to the bottom part 116b than the pair of short sides (the third side 113 and the fourth side 114). As shown in FIG. 3, when a length from the first side 111 to the second side 112 of the first wall 110 is treated as L, it is preferable that the bottom part 116b is spaced apart from the first side 111 and the second side 112 by ⅕ L or more, or it is further preferable that it is spaced apart by ¼ L or more. When the bottom part 116b is pushed by the electrode assembly 20, there is a tendency that a larger stress is applied to a portion closer to the bottom part 116b of the outer edge of the first wall 110. Thus, in a situation where the first side 111 and the second side 112 are spaced apart from the bottom part 116b, it is comparatively possible to reduce the stress generated on the first side 111 and the second side 112.

In some embodiments, when an area size of the first wall 110 is treated as 100%, an area size of the bottom part 116b of the hollow part 116 is, for example, equal to or more than 20% and not more than 60%. In a situation where the area size of the bottom part 116b is too small, a contact area size of the electrode assembly 20 with the bottom part 116b becomes small, and thus it might cause a breakage on the electrode assembly 20. Therefore, the area size ratio of the bottom part 116b with respect to the area size of the first wall 110 is preferably, for example, equal to or more than 30%. In addition, if the area size of the bottom part 116b is too large, the distance between the bottom part 116b and the outer edge of the first wall 110 becomes smaller, and thus, the stress applied to the outer edge of the first wall 110 can be larger. Therefore, the area size ratio of the bottom part 116b with respect to the area size of the first wall 110 might be, for example, equal to or less than 50%, or not more than 40%. Incidentally, the area size of the first wall 110 and the area size of the bottom part 116b of the hollow part 116 represent area sizes on a visual field from an opposed direction of the first wall 110 and the second wall 120 (a visual field from the F side toward the Rr side in the short side direction Y of FIG. 1).

The inclined part 116a is arranged between the bottom part 116b and the base part 115. The inclined part 116a is inclined from the base part 115 toward the bottom part 116b. In other words, the inclined part 116a is inclined from the base part 115 toward the electrode assembly 20. The inclined part 116a is herein linearly inclined from the base part 115 toward the bottom part 116b. Incidentally, in some embodiments, the inclined part 116a might be curved toward the inner side or the outer side of the case 100.

An angle θ of the inclined part 116a with respect to the base part 115 is not particularly restricted, but is, for example, preferably less than 30°, or further preferably less than 20°. If the angle θ is too large, a boundary between the inclined part 116a and the base part 115 tends to be easily broken. Although not particularly restricted, a lower limit of the angle θ might be, for example, equal to or more than 5°, equal to or more than 10°, or equal to or more than 15°. If the angle θ is too small, it is difficult to make the hollow part 116 have a sufficient depth, the electrode assembly 20 and the base part 115 may come into contact with each other.

The hollow part 116 can be formed, for example, by a pressing process. Thicknesses of the inclined part 116a and bottom part 116b of the hollow part 116 might be approximately the same as the base part 115 (for example, within a ±10% range of the thickness of the base part 115).

The recessed part 115a is provided at least between the first side 111 of the first wall 110 and the hollow part 116. Here, the recessed part 115a might be provided to surround the hollow part 116. In other words, the recessed part 115a is provided in a ring-shaped manner between the outer edge of the first wall 110 and the hollow part 116. Here, the recessed part 115a is provided continuously (in a groove-shaped manner). Incidentally, in some embodiments, the recessed part 115a might be provided intermittently.

The recessed part 115a is recessed toward the inner side or the outer side of the case 100. The recessed part 115a might be a bent part that is configured with the first wall 110 being partially bent. A bottom part of the recessed part 115a is configured to protrude from the inner surface of the case 100 toward the electrode assembly 20 or to protrude from the outer surface of the case 100 toward the outside of the case 100. Preferably, the recessed part 115a is a curved part that is configured to be bent to the inner side or the outer side of the case 100. Here, the recessed part 115a is configured to be curved to the inner side of the case 100. By making the recessed part 115a be recessed (here, be curved) toward the inner side of the case 100, a protruding part is not formed at the outer side of the first wall 110 of the case 100. Accordingly, when a restriction pressure is applied from the outer side of the case 100 in the opposed direction of the first wall 110 and the second wall 120, it is possible to reduce a variation in the restriction pressure.

The thickness of the recessed part 115a (in other words, a thickness of a part configuring the recessed part 115a) might be approximately the same as the base part 115 (for example, within ±10% range of the thickness of the base part 115). The recessed part 115a can be formed, for example, by the pressing process or a folded and bent process.

There is a space between the recessed part 115a and the electrode assembly 20, and thus it is configured to prevent the inner side surface of the base part 115 and the electrode assembly 20 from coming into contact with each other. In the present embodiment, the recessed part 115a is recessed toward the inner side of the case 100, and thus the depth of the recessed part 115a is smaller than the depth of the hollow part 116.

By the study of the present inventor, it has been found that the stress is reduced by making the length of the member configuring the first wall 110 be longer within a range from the bottom part 116b of the hollow part 116 of the first wall 110 coming into contact with the electrode assembly 20 to the outer edge of the first wall 110. Although details are omitted, it has been confirmed by a computer simulation that, on the first wall 110 in the present embodiment, the maximum stress is reduced by about 60% in comparison with a situation in which a flat surface plate (in other words, a plate including neither a portion corresponding to the hollow part 116 nor a portion corresponding to the recessed part 115a) is used instead of the first wall 110. Although it is not particularly restricted, a mechanism for reducing the stress can be explained on the basis of a beam theory. In summary, by providing the recessed part 115a, the length of the member configuring a portion of the first wall 110 from the bottom part 116b of the hollow part 116 to the outer edge of the first wall 110 (a length of the member before a deformation process for providing the recessed part 115a) becomes longer. If the length described above becomes longer, the stress can be relieved further. In particular, by making the recessed part 115a be curved, the stress concentration on the recessed part 115a is suppressed, and thus it is possible to suitably obtain a stress relief effect.

(2) Electrode Assembly 20

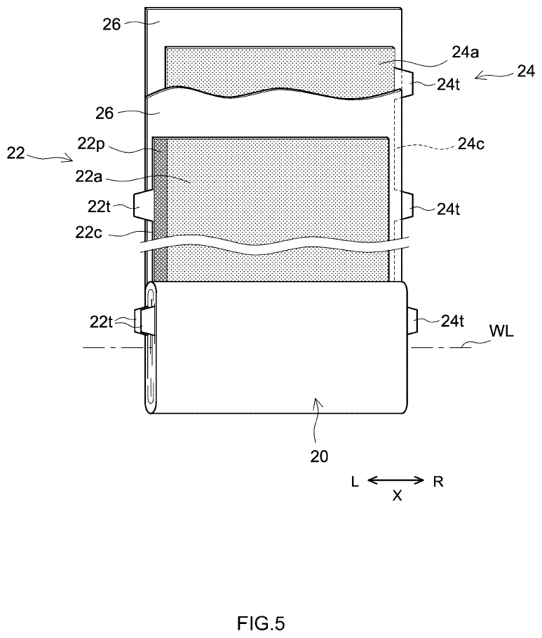

The electrode assembly 20 is a power generating element of the electricity storage device 1. FIG. 5 is a schematic view in which the electrode assembly 20 is decomposed. As shown in FIG. 5, the electrode assembly 20 includes a positive electrode 22 and a negative electrode 24. The electrode assembly 20 includes a laminate part 28 in which the positive electrode 22 and the negative electrode 24 are laminated in a state of being insulated (see FIG. 3). Here, the positive electrode 22 and the negative electrode 24 are insulated by a separator 26. The electrode assembly 20 is a flat-shaped wound electrode assembly in which the strip-shaped positive electrode 22 and the strip-shaped negative electrode 24 are laminated via the strip-shaped separator 26 and are wound therein with a winding axis WL being treated as a center. The electrode assembly 20 is accommodated at the inside of the case 100 so as to make the winding axis WL be approximately parallel to the long side direction X. In addition, the electrode assembly 20 is arranged to make the laminate part 28 be along the opposed direction (the short side direction Y) of the first wall 110 and the second wall 120 of the case 100. The laminate part 28 is opposed to the bottom part 116b of the hollow part 116 provided on the first wall 110 of the case 100. Although illustrations are omitted, an insulating member for inhibiting a continuity (for example, an insulation film made of resin) is arranged between the electrode assembly 20 and the case 100.

As shown in FIG. 3, the electrode assembly 20 includes a pair of curved parts 20r. The pair of curved parts 20r are configured to be respectively opposed to the first side wall 130 and the second side wall 140 of the case 100. The laminate part 28 is formed between the pair of curved parts 20r. The laminate part 28 is a flat part of the electrode assembly 20. A volume change of the laminate part 28, in comparison to that of the curved part 20r, tends to be larger at an electrically charging time.

The positive electrode 22 includes a positive electrode current collector 22c that is an electrically conductive metal foil, includes a positive electrode active material layer 22a that is arranged on a surface of the positive electrode current collector 22c, and includes a positive electrode protection layer 22p. The positive electrode current collector 22c herein is formed in a strip-like shape. The positive electrode current collector 22c consists of, for example, an electrically conductive metal, such as aluminum, aluminum alloy, nickel, and stainless steel. The positive electrode current collector 22c herein is a metal foil, in particular, an aluminum foil.

The positive electrode active material layer 22a is provided in a strip-like shape along a longitudinal direction of the strip-shaped positive electrode current collector 22c. The positive electrode active material layer 22a contains an active material (for example, a lithium-transition metal complex oxide, such as lithium-nickel-cobalt-manganese composite oxide) that can reversibly store and release an electrical charge carrier. The positive electrode active material layer 22a might contain an arbitrary component other than the active material, such as electrically conducting material, binder, and various additive components. As the electrically conducting material, for example, it is possible to use a carbon material, such as acetylene black (AB). As the binder, for example, it is possible to use polyvinylidene fluoride (PVDF), or the like.

The positive electrode protection layer 22p is provided at a position adjacent to the positive electrode tab 22t side of the positive electrode active material layer 22a in a width direction of the positive electrode 22 (in the long side direction X). A material of the positive electrode protection layer 22p might be similar to conventional one. The positive electrode protection layer 22p can contain, for example, an inorganic filler (for example, alumina), a binder (for example, PVDF), an electrically conducting material (for example, acetylene black), or the like.

On the positive electrode 22, the positive electrode tab 22t is provided. The positive electrode tab 22t herein is a part of the positive electrode current collector 22c. The positive electrode tab 22t is configured to protrude from an edge of the positive electrode current collector 22c in the width direction of the positive electrode 22 (in the long side direction X). The positive electrode tab 22t is configured to protrude toward the third side wall 150 of the case 100 (see FIG. 2). On at least a part of the positive electrode tab 22t, an area where the positive electrode current collector 22c is exposed is formed. The positive electrode tab 22t is electrically connected to the positive electrode terminal 30 via a positive electrode current collector part 32. Incidentally, the positive electrode tab 22t might be a member different from the positive electrode current collector 22c.

The negative electrode 24 includes a negative electrode current collector 24c that is an electrically conductive metal foil, and includes a negative electrode active material layer 24a that is arranged on a surface of the negative electrode current collector 24c. The negative electrode current collector 24c herein is formed in a strip-like shape. The negative electrode current collector 24c consists of, for example, an electrically conductive metal, such as copper, copper alloy, nickel, and stainless steel. The negative electrode current collector 24c herein is a metal foil, and it is, in particular, a copper foil.

The negative electrode active material layer 24a is provided in a strip-like shape along the longitudinal direction of the strip-shaped negative electrode current collector 24c. The negative electrode active material layer 24a contains an active material (for example, a carbon material, such as graphite, or a silicon containing material, such as silicon oxide and silicon containing graphite) that can reversibly store and release the electrical charge carrier. The negative electrode active material layer 24a might contain an arbitrary component other than the active material, for example, various additive components, such as binder and dispersing agent, or the like. As the binder, for example, it is possible to use styrene butadiene rubber (SBR), or the like. As the dispersing agent, for example, it is possible to use celluloses, such as carboxymethyl cellulose (CMC).

On the negative electrode 24, the negative electrode tab 24t is provided. In the present embodiment, the negative electrode tab 24t is a part of the negative electrode current collector 24c. The negative electrode tab 24t is configured to protrude from an edge of the negative electrode current collector 24c in a width direction of the negative electrode 24 (in the long side direction X). The negative electrode tab 24t is configured to protrude toward the fourth side wall 160 of the case 100 (see FIG. 2). On at least a part of the negative electrode tab 24t, an area where the negative electrode current collector 24c is exposed is formed. The negative electrode tab 24t is electrically connected via a negative electrode current collector part 42 to the negative electrode terminal 40. Incidentally, the negative electrode tab 24t might be a member different from the negative electrode current collector 24c.

The separator 26 is, as shown in FIG. 5, a member configured to establish an insulation between the positive electrode 22 and the negative electrode 24. As the separator 26, for example, it is suitable to use a porous sheet made of resin consisting of polyolefin resin, such as polyethylene (PE) and polypropylene (PP). The separator 26 might include a base material part that consists of a porous sheet made of resin and include a heat resistance layer (HRL) that is provided on at least one of surfaces of the base material part and that contains an inorganic filler. As the inorganic filler, for example, it is possible to use alumina, boehmite, aluminum hydroxide, titania, or the like.

The positive electrode terminal 30 and the negative electrode terminal 40 herein are respectively fixed on opposed surfaces of the case 100. The positive electrode terminal 30 is attached to the third side wall 150 (a left side in the long side direction X of FIG. 2). The positive electrode terminal 30 is inserted into the first penetration hole 152 so as to be partially exposed to the outside of the case 100 and to be partially arranged at the inside of the case 100. It is preferable that the positive electrode terminal 30 is made of metal, and it is more preferable that the positive electrode terminal is made of, for example, aluminum or aluminum alloy. As shown in FIG. 2, the positive electrode terminal 30 is electrically connected via the positive electrode current collector part 32 to the positive electrode tab 22t at the inside of the case 100. Incidentally, in another embodiment, the positive electrode current collector part 32 can be omitted.

The negative electrode terminal 40 is attached to the fourth side wall 160 (a right side in the long side direction X of FIG. 2). The negative electrode terminal 40 is inserted into the second penetration hole 162 so as to be partially exposed to the outside of the case 100 and to be partially arranged at the inside of the case 100. It is preferable that the negative electrode terminal 40 is made of metal, and it is more preferable that the negative electrode terminal is made of, for example, copper or copper alloy. As shown in FIG. 2, the negative electrode terminal 40 is electrically connected via the negative electrode current collector part 42 to the negative electrode tab 24t at the inside of the case 100. Incidentally, in another embodiment, the negative electrode current collector part 42 can be omitted. Additionally, in some embodiments, the positive electrode terminal 30 and the negative electrode terminal 40 might be provided on the same wall.

In order to prevent the positive electrode terminal 30 and the negative electrode terminal 40 from establishing a continuity with the case 100, the insulating member 50 is arranged between the positive electrode terminal 30 and the case 100, and between the negative electrode terminal 40 and the case 100. The insulating member 50 can be, for example, configured with a fluorine-based resin, such as perfluoro alkoxy alkane (PFA) and poly tetra fluoro ethylene (PTFE), or a synthetic resin material, such as poly phenylene sulfide (PPS).

The nonaqueous electrolytic solution is accommodated at the inside of the case 100. The nonaqueous electrolytic solution might be the same as conventional one, and is not particularly restricted. The nonaqueous electrolytic solution is a nonaqueous type liquid electrolyte that contains a nonaqueous solvent and a supporting salt. The nonaqueous solvent contains, for example, carbonates, such as ethylene carbonate (EC), ethyl methyl carbonate (EMC), and dimethyl carbonate (DMC). The supporting salt (the electrolyte salt) contains, for example, a fluorine-containing lithium salt, such as LiPF₆. Incidentally, in some embodiments, the nonaqueous electrolyte might be in a gel form, or might be in a solid form (a solid electrolyte) that is integrated with the electrode assembly.

As described above, the electricity storage device 1 includes the case 100 including the first wall 110. The first wall 110 includes the base part 115, and the hollow part 116 that is configured to protrude from the base part 115 toward the electrode assembly 20. The hollow part 116 includes the inclined part 116a that is configured to be inclined from the base part 115 toward the electrode assembly 20, and includes the bottom part 116b that is positioned closer to the electrode assembly 20 than the base part 115. The base part 115 includes the recessed part 115a between the hollow part 116 and the first side 111, and the recessed part is configured to be recessed to the inner side or the outer side of the case 100.

In respect of the electricity storage device 1, when the electrode assembly 20 is expanded due to the electrical charge, or the like, a force is generated by which the electrode assembly 20 pushes the bottom part 116b of the hollow part 116 of the first wall 110 toward the outer side of the case 100. By this, a stress is generated at a position near the first side 111 of the first wall 110. In the electricity storage device 1, the recessed part 115a is provided between the bottom part 116b and the first side 111. This allows further reduce the stress applied to the position near the first side 111 (near a corner part of the case 100), in comparison with a situation where a portion between the bottom part 116b and the first side 111 is formed in a flat plate shape (a situation where the recessed part 115a is not provided).

The electricity storage device 1 can be used for various purposes. As a suitable purpose, it can be used for an in-vehicle application, in particular, for a driving power supply that is mounted on a vehicle, such as battery electric vehicle (BEV), hybrid electric vehicle (HEV), and plug-in hybrid electric vehicle (PHEV). In addition, the electricity storage device 1 can be used for a storage battery, such as small electric power storage apparatus. The electricity storage device 1 can be used even in a form of a battery module typically configured by plural electricity storage devices being connected in series and/or in parallel.

Above, the herein disclosed some embodiments have been explained, but the above described embodiments are merely examples. The present technique can be implemented in various other forms. The technique recited in the appended claims includes variously deformed or changed versions of the embodiments that have been illustrated above. For example, one part of the above described embodiment can be replaced with another deformed aspect, and furthermore another deformed aspect can be added to the above described embodiment. In addition, unless a technical feature is explained to be essential, this technical feature can be appropriately deleted.

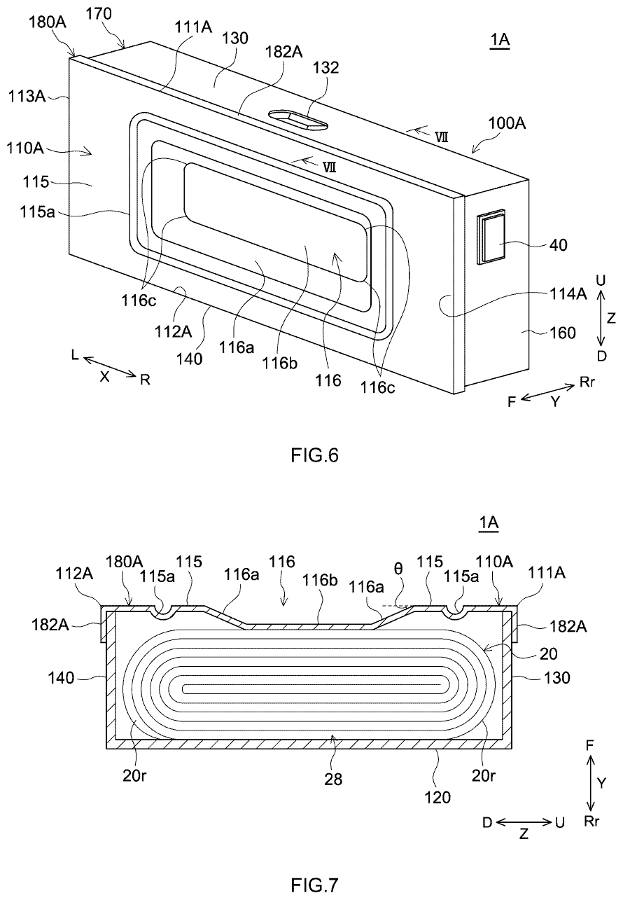

In the above described embodiment, the sealing body 180 is fit into the dent step 170s of the opening 170h of the case main body 170, the first wall 110 is configured with the sealing body 180 and the end surface of the side wall of the case main body 170, but it is not restricted to this. FIG. 6 is a perspective view that schematically shows a configuration of an electricity storage device 1A being a modified example. FIG. 7 is a cross section view that is schematically shown along a VII-VII line of FIG. 6. As shown in FIG. 6 and FIG. 7, regarding the electricity storage device 1A, a case 100A includes the case main body 170 and a sealing body 180A. A first wall 110A is configured with the sealing body 180A. The sealing body 180A includes a bent part 182A that is bent at an outer edge of the first wall 110A (for more detail, at a first side 111A, a second side 112A, a third side 113A, and a fourth side 114A). The bent part 182A is configured to extend along the outer surface of the side wall of the case main body 170. In the electricity storage device 1A, the bent part 182A configures at least a part of the first side wall 130, the second side wall 140, the third side wall 150, and the fourth side wall 160. The sealing body 180A includes a surface (the first wall 110A) whose area size is larger than the opening 170h of the case main body 170, so as to cover the opening 170h of the case main body 170. The sealing body 180A and the case main body 170 are joined, for example, by a laser welding the bent part 182A and the side wall of the case main body 170. In respect to the electricity storage device 1A, a welding part is not provided at the outer edge of the first wall 110A. Thus, it becomes easy to avoid concentrating the stress on the welding part.

Additionally, in the above described embodiment, only one recessed part 115a is provided between the outer edge of the first wall 110 and the hollow part 116, but the present disclosure is not restricted by this. Two or more recessed parts might be provided between the outer edge of the first wall 110 and the hollow part 116. In a situation where two or more recessed parts 115a are provided, the recessed part configured to protrude toward the inner side of the case 100 and the recessed part configured to protrude toward the outer side of the case 100, both of them, might be formed. For example, by bending the first wall 110 to be formed in a corrugated sheet shape so as to make a concave and convex part along a direction from the hollow part 116 toward the outer edge of the first wall 110, it is possible to provide two or more recessed parts continuously. By providing two or more recessed parts (containing the corrugated sheet shape), a length of a member, configuring the first wall 110 from a position (the bottom part 116b) at which the electrode assembly 20 pushes the first wall 110 toward the outer side to the outer edge of the first wall 110, is extended and thus it is possible to further relieve the stress generated on the outer edge of the first wall 110.

Additionally, in the above described embodiment, the electrode assembly 20 is the wound electrode assembly, but the present disclosure is not restricted to this. For example, the electrode assembly might be a laminate electrode assembly in which plural square (typically, rectangular) sheet-shaped positive electrodes and plural square (typically, rectangular) sheet-shaped negative electrodes are stacked in an insulated state. (

Additionally, in the above described embodiment, the single electrode assembly 20 is accommodated in the case 10, but the present disclosure is not restricted to this. In some embodiments, two or more the electrode assemblies might be accommodated in the case.

Additionally, in the above described embodiment, the positive electrode tab 22t and the negative electrode tab 24t are configured to respectively protrude from different end surfaces of the electrode assembly 20, but the present disclosure is not restricted to this. In some embodiments, the positive electrode tab and the negative electrode tab might be configured to protrude from the same end surface of the electrode assembly.

Additionally, in the above described embodiment, the bottom part 116b of the hollow part 116 of the first wall 110 and the electrode assembly 20 are configured to directly come into contact with each other, but the present disclosure is not restricted to this. In some embodiments, the bottom part 116b of the hollow part 116 of the first wall 110 and the electrode assembly 20 might be configured to indirectly come into contact with each other via another member. For example, an insulating member might be arranged between the bottom part 116b and the electrode assembly 20. In addition, the bottom part 116b of the hollow part 116 and the electrode assembly 20 might be configured to not always directly or indirectly come into contact with each other. For example, if it is configured to make it come into contact with the bottom part 116b of the hollow part 116 at first among the first wall 110 at the time when the electrode assembly 20 is expanded (for example, at the electrically charging time), it is sufficient.

While described above, the following items are given as examples of specific aspects of the art disclosed herein.

### Item 1:

An electricity storage device, comprising:
a case; and
an electrode assembly that is accommodated in the case, wherein
the case comprises:
   a first wall that comprises an outer edge containing a first side and a second side being opposed to the first side; and
   a second wall that is opposed to the first wall,
the electrode assembly comprises a laminate part in which a positive electrode and a negative electrode are laminated along an opposed direction of the first wall and the second wall in a state of being insulated,
the first wall comprises:
   a base part; and
   a hollow part that is configured to protrude from the base part toward the electrode assembly,
the hollow part comprises:
   an inclined part that is inclined from the base part toward the electrode assembly; and
   a bottom part that is positioned closer to the electrode assembly than the base part, and
the base part comprises a recessed part that is positioned between the hollow part and the first side and that is recessed toward an inner side or an outer side of the case.
   Item 2: The electricity storage device recited in Item 1, wherein
when a length of the first wall from the first side to the second side is treated as L, the bottom part of the hollow part is spaced apart from the first side and the second side by ⅕ L or more.
   Item 3: The electricity storage device recited in Item 1 or 2, wherein

the recessed part is provided to surround the hollow part.

Item 4: The electricity storage device recited in any one of Items 1 to 3, wherein

when an area size of the first wall is treated as 100%, an area size of the bottom part of the hollow part is equal to or more than 20% and not more than 60%.

Item 5: The electricity storage device recited in any one of Items 1 to 4, wherein
an angle of the inclined part of the hollow part with respect to the base part is less than 30°.
   Item 6: The electricity storage device recited in any one of Items 1 to 5, wherein
the recessed part is a curved part.
   Item 7: The electricity storage device recited in any one of Items 1 to 6, wherein
the first wall has an approximately rectangular shape, and the first side and the second side configure a pair of long sides of the first wall.

What is claimed is:

1. An electricity storage device, comprising:
a case; and
an electrode assembly that is accommodated in the case, wherein
the case comprises:
a first wall that comprises an outer edge containing a first side and a second side being opposed to the first side; and
a second wall that is opposed to the first wall,
the electrode assembly comprises a laminate part in which a positive electrode and a negative electrode are laminated along an opposed direction of the first wall and the second wall in a state of being insulated,
the first wall comprises:
a base part; and
a hollow part that is configured to protrude from the base part toward the electrode assembly,
the hollow part comprises:
an inclined part that is inclined from the base part toward the electrode assembly; and
a bottom part that is positioned closer to the electrode assembly than the base part, and
the base part comprises a recessed part that is positioned between the hollow part and the first side and that is recessed toward an inner side or an outer side of the case.

2. The electricity storage device according to claim 1, wherein
when a length of the first wall from the first side to the second side is treated as L, the bottom part of the hollow part is spaced apart from the first side and the second side by ⅕ L or more.

3. The electricity storage device according to claim 1, wherein the recessed part is provided to surround the hollow part.

4. The electricity storage device according to claim 1, wherein
when an area size of the first wall is treated as 100%, an area size of the bottom part of the hollow part is equal to or more than 20% and not more than 60%.

5. The electricity storage device according to claim 1, wherein
an angle of the inclined part of the hollow part with respect to the base part is less than 30°.

6. The electricity storage device according to claim 1, wherein the recessed part is a curved part.

7. The electricity storage device according to claim 1, wherein
the first wall has an approximately rectangular shape, and the first side and the second side configure a pair of long sides of the first wall.
